(19) United States
(12) Patent Application Publication
(10) Pub. No.: US 2005/0100747 A1
(43) Pub. Date: May 12, 2005

(54) Weatherstrip for automotive glass window and the like

(76) Inventors: Krishnamachari Gopalan, Troy, TN (US); Ramaswamy G. Raj, Troy, MI (US); Christopher D. Schneider, Peru, IN (US)

Correspondence Address: BRINKS HOFER GILSON & LIONE, P.O. BOX 10395, CHICAGO, IL, 60610, US

(21) Appl. No.: 10/984,218

(22) Filed: Nov. 9, 2004

Related U.S. Application Data
(60) Provisional application No. 60/519,363, filed on Nov. 12, 2003.

(51) Int. Cl. B32B 13/12; B32B 9/04

(52) U.S. Cl. 428/447; 428/451

(57) ABSTRACT

A weatherstrip for automotive and motor vehicle window glass comprises a glass contact layer overlying a base extrusion. The base extrusion is formed of a thermoplastic vulcanizate (TPV) comprising ethylene-propylene diene polymer (EPDM) and polypropylene. The glass contact layer is formed of a material composed predominantly of a thermoplastic polyolefin polymer and comprising a silicone-crosslinked thermoset polymer. The thermoset polymer may be the reaction product of a silane-grafted polyolefin and a silicone polymer.

### CROSS-REFERENCE TO RELATED APPLICATIONS

The present invention claims priority to U.S. Provisional Ser. No. 60/519,363, filed Nov. 12, 2003, entitled “Weatherstrip for Automotive Glass Window and the Like.”

### TECHNICAL FIELD OF THE INVENTION

This invention relates to a weatherstrip for sealing an automotive glass window or the like. More particularly, this invention relates to a weatherstrip that includes a glass contact layer overlying a portion of a polyolefin extrusion, which glass contact layer is formed of a thermoplastic polyolefin polymer phase and a silicone-crosslinked thermoset polymer matrix.

### BACKGROUND OF THE INVENTION

Most automotive vehicles are equipped with moveable windows that slide in a window frame between a closed position wherein the window closes and seals an opening and an open position wherein the window is retracted within a door or body panel. Weatherstrip is disposed about the periphery of the window opening and provides an airtight and watertight seal between the window and the frame. One type of weatherstrip, referred to as a beltstrip, is disposed adjacent the window where the window retracts into the door or body panel and includes a wiper flange that wipes the surface as the window is retracted or raised. Another type of weatherstrip, referred to as an edge seal, defines a groove that slidably receives an edge of the window and includes surfaces that form a seal against the window.

A typical and conventional weatherstrip comprises an extrusion formed of a soft synthetic rubber-like material. Suitable material is characterized by resiliency over a wide range of temperatures and excellent weather resistance which minimizes deterioration due to heat, oxidation or other conditions typically encountered in automotive environments. A common material contains an ethylene-propylene rubber, referred to as EPDM, and is compounded with fillers and crosslinking agents. Recently, thermoplastic vulcanizates, referred to as TPV, have been developed that are a blend of EPDM and polypropylene or other suitable polyolefin polymers. The weatherstrip is formed by extrusion and features a smooth surface. Carbon black or other pigment is typically added to provide a dark, black coloration. The smooth surface and black coloration provide an aesthetically pleasing appearance on the automotive vehicle.

To facilitate sliding and sealing of the weatherstrip against the window, it is known to apply a glass contact layer to portions of the weatherstrip. One type of glass contact layer is formed by adhesively applying a fibrous flock to the glass contact surfaces. It is also known to apply a glass contact layer formed of a thermoplastic material containing agents that reduce the coefficient of friction to promote sliding and sealing against the glass and also provide wear resistance for extended life of the weatherstrip on the vehicle. Suitable additives include grains of high melting temperature polymeric material, mica, molybdenum sulfide, and fluororesins. The additives are mixed with the EPDM or other thermoplastic resin and extruded onto the base.

A problem of such applied glass contact layers formed of thermoplastic polymers is that they tend to discolor when flexed, an effect referred to as stress whitening. They also frequently form wrinkles. Stress whitening and wrinkling detract from the desired smooth, black appearance of the weatherstrip.

There is therefore a need for a weatherstrip having an improved glass contact layer applied to a base formed of TPV, EPDM or other suitable rubber-like polymer, which glass contact layer not only exhibits a low coefficient of friction to promote sliding and sealing of the glass contact layer against a window, but also exhibits reduced stress whitening and wrinkling that would otherwise detract from the desired aesthetic appearance of the weatherstrip.

### SUMMARY OF THE INVENTION

In accordance with this invention, a weatherstrip for motor vehicle window glass comprises an improved glass contact layer overlying portions of a base extrusion. A preferred base extrusion is formed of a thermoplastic vulcanizate (TPV) comprising ethylene-propylene diene polymer (EPDM) and polypropylene. The glass contact layer is formed of a material composed predominantly of a thermoplastic polyolefin polymer and comprising a silicone-crosslinked thermoset polymer. A preferred thermoset polymer is the reaction product of a silane-grafted polyolefin and a silicone polymer.

While the patentees intend not to be limited to any particular theory, it is believed that thermoplastic polyolefin polymer forms a continuous phase within the glass contact layer that is reinforced by the silicone-crosslinked polymer. The layer exhibits a low coefficient of friction to facilitate sliding and sealing contact with the glass. The thermoset network provides elasticity and reinforces the thermoplastic phase to inhibit displacement due to flexing or contact pressure. As a result, the glass contact layer resists localized variations that would otherwise result in stress whitening and wrinkling. Thus, this invention provides a robust weatherstrip that maintains an aesthetically pleasing smooth black appearance and is particularly well suited for use in automotive applications and the like.

### BRIEF DESCRIPTION OF THE DRAWINGS

This invention will be further described with reference to the following drawings wherein like reference numbers in the two drawings refer to the same component, element or feature:

FIG. 1 is a side elevational view of a motor vehicle having a passenger compartment and a door incorporating the present invention; and

FIG. 2 is a cross-sectional view of a weatherstrip in accordance with a preferred embodiment of the invention taken along line 2-2 of FIG. 1.

### DETAILED DESCRIPTION OF THE INVENTION

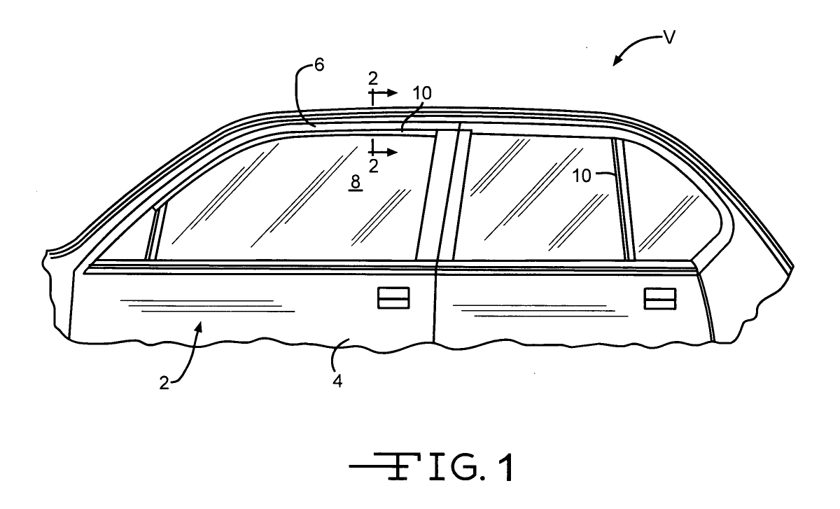

Referring now to FIG. 1, a typical motor vehicle such as a passenger car, sport utility vehicle (SUV), station wagon or pick-up truck is illustrated and designated by the reference letter V. The motor vehicle V includes doors 2 each having an upper freestanding frame portion 4 which extends from a lower panel section 6. The frame portion 4 and the lower panel section 6 cooperatively define a window opening which receives a window or glass light 8. A weatherstrip 10 is disposed about the inside of the window opening and engages the glass light 8.

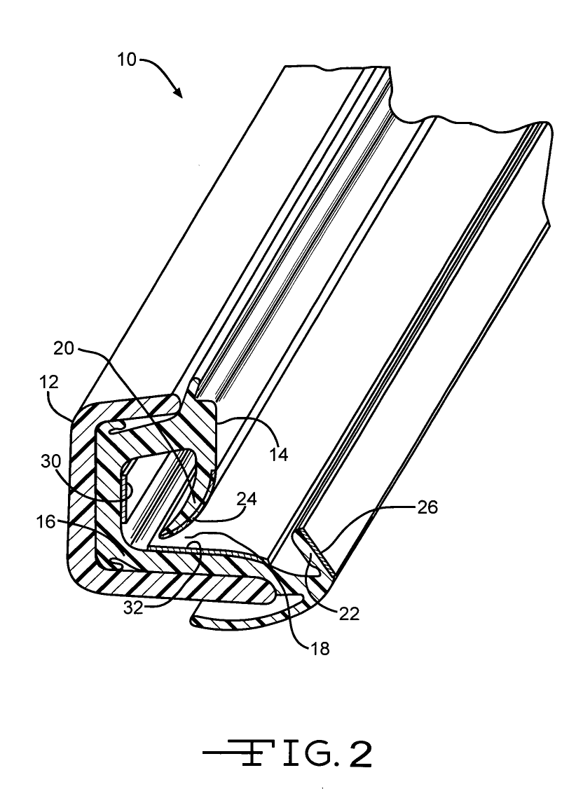

Referring to FIG. 2, there is depicted a weatherstrip 10 that is especially adapted for use in a vehicle V for slidably receiving an edge of a glass window or light 8 and forming an airtight and watertight seal thereagainst. It will be appreciated that the weatherstrip 10 depicted in FIG. 2 is a conventional and typical design and is by way of example only. The particular design of the weatherstrip depends upon the nature of the application (beltstrip or edge seal), the design of the door or panel and other factors. It is an advantage of this invention that it may be readily adapted for incorporation in weatherstrips of other configurations.

In the preferred embodiment, the weatherstrip 10 comprises, as main components, a rigid support 12 and a resilient extrusion 14. As illustrated in FIG. 2, the rigid support 12 is adapted for mounting the weatherstrip 10 in a door 2 or body panel in a motor vehicle V and defines a U-shaped channel. The rigid support 12 is suitably formed of a black-pigmented rigid polymeric material, preferably a nylon resin.

The resilient extrusion 14 is received within the rigid support 12 and defines a groove 18 for slideably receiving an edge of the window or glass light 8. For this purpose, the extrusion 14 includes a flexible web 16 to allow the extrusion 14 to be suitably shaped to conform to the rigid support 12. In a preferred embodiment, the extrusion 14 is composed of a thermoplastic vulcanizate polymer, TPV. A preferred TPV comprises a compound of ethylene propylene rubber, EPDM, and a polypropylene polymer and is characterized by resiliency and weatherability over a wide temperature range typical of automotive and motor vehicle applications. Suitable TPV is commercially available from Advanced Elastomer Systems, Inc., under the trade designation Santoprene 121-67W175. Alternately, the extrusion 14 may be suitably formed of a thermoset EPDM material.

The resilient extrusion 14 comprises two flanges 20 and 22 on opposite sides of the groove 18 for flexibly engaging opposite sides of the window or light 8 when inserted into the groove 18. In accordance with this invention, the resilient extrusion 14 includes two glass contact layers 24 and 26 that overlie portions of the resilient extrusion 14 and are strategically located for intimate contact with the window or light 8. During extension and retraction of the window 8 into the groove 18, the window 8 slides against the contact layers 24 and 26. In addition, the contact layers 24 and 26 maintain contact with the window 8 when inserted into the groove 18 to provide an airtight and watertight seal.

In accordance with this invention, the glass contact layers 24 and 26 are preferably formed of a blend of a thermoplastic polymer and a thermoset polymer. The thermoplastic polymer is a polyolefin, preferably polyethylene. The thermoset polymer is a reaction product of a silane-grafted polyolefin and a silicone polymer. The preferred silane-grafted polyolefin is a polyethylene material modified to include silane reaction groups. The preferred silicone polymer is characterized by an average molecular weight in the range of about 300,000 to 400,000. Upon curing, the silane-grafted polyolefin and the silicone polymer react to crosslink the polymers and form a polymeric network within the product composition.

By way of a preferred example, the glass contact layers 24 and 26 may be formulated to contain, by weight, 90 percent high density polyethylene (HDPE); 5 percent silicone polymer solution, and 5 percent silane-grafted polymer. A suitable HDPE is obtained from Mutsui Co. under the trade designation Lubmer L3000 and is characterized by a high molecular weight and a coefficient of friction of about 0.1. A suitable silicone polymer solution is a liquid containing 50 percent silicone polymer and the balance a polypropylene vehicle and is obtained from Dow Corning, Inc., under the trade designation MB 50-321. The silicone polymer is preferably characterized by an ultrahigh molecular weight between about 300,000 and 400,000. Dissolution in the polypropylene vehicle allows the silicone polymer to be readily blended with the HDPE, but it is believed that the polypropylene does not significantly contribute to the properties of the product. A suitable silane-grafted polymer is polyethylene grafted with vinyltrimethoxysilane and is obtained from Union Carbide Corp. under the trade designation Sioplas E.

The constituents are blended and extruded onto a TPV base at a temperature between 250° F. and 500° F. (121° C. to 260° C.). The melt emerging from the extruder reacts with ambient moisture to cure the layer. Preferably, the resulting layer exhibits a coefficient of friction less than 0.25, and preferably about 0.07 and 0.17. The layer preferably withstands a chisel test using a 6.6 pound (3 kilogram) load for 100,000 cycles. The product layer is also characterized by resistance to stress whitening and wrinkling during bend testing.

While patentees intend not to be limited to any particular theory, it is believed that the silane and the silicone react to crosslink the polymers and form a network that provides elasticity for the product composition. The preferred composition is predominantly composed of a continuous thermoplastic phase formed by the polyolefin polymer, preferably polyethylene or polypropylene. In general, amounts greater than 80 weight percent are effective to produce a glass contact layer 24, 26 having a low coefficient of friction conducive to sliding contact with the window 8. In addition, the sealing properties of the glass contact layer for forming an airtight and watertight seal are also mainly attributed to the predominant polyolefin phase. A preferred composition contains between about 85 and 90 weight percent polyolefin phase. The crosslinked polymer is formed from a high molecular weight silicone. In the described example, the silicone precursor is characterized by an ultra high molecular weight between about 300,000 and 400,000. During mixing, the additive is dispersed in the polyolefin phase, so that the resulting crosslinked network permeates the product composition. In the described example, the silicone additive is added as a solution with polypropylene to promote mixing with the predominant polyolefin phase. In general, it is believed that a suitable reinforcement network is formed by adding up to 5 weight percent silicone precursor, and preferably between 2 and 3 weight percent. It is preferred to add silane precursor in excess of stoichiometric proportions to assure complete reaction of the silicone, so that the product composition that is essentially free of unreacted silicone polymer. For the preferred silane-grafted polyethylene, amounts may be suitably added up to 10 weight percent and are preferably between 3 and 7 weight percent. Optionally, black pigment agent or other additives may be added.

The weatherstrip 10 also includes two second or additional glass contact layers 30 and 32 that are disposed within the groove 18. The two second contact layers 30 and 32 may be suitably formed of a composition similar to the two glass contact layers 24 and 26. It is pointed out that the two second layers 30 and 32 are disposed internally within the groove 18 and are not readily visible. As a result, whitening and wrinkling of the two second layers 30 and 32 does not significantly detract from the appearance of the weatherstrip 10. Thus, the two second layers 30 and 32 may be suitably formed of wear-resistant thermoplastic polymer, such as HDPE that does not include a silicone network in accordance with this invention.

This invention thus provides a weatherstrip 10 comprising a glass contact layer formed predominantly of thermoplastic polyolefin and reinforced by a silicone-crosslinked network. It is believed that the silicone-crosslinked network inhibits displacement of the thermoplastic phase due to flexing or the like that would otherwise result in stress whitening or wrinkling. Thus, the improved glass contact layers 24, 26, 30, 32 in accordance with this invention provide a desired smooth black appearance with good wear and weather resistance.

While this invention has been described in terms of certain embodiments thereof, it is not intended to be so limited, but rather should be limited only to the extent set forth in the claims that follow.

1. A weatherstrip for sealing a window in a motor vehicle comprising:
a base extrusion and
a glass contact layer overlying a portion of the base extrusion, said glass contact layer being composed predominantly of a continuous thermoplastic polyolefin phase and comprising a silicone-crosslinked network reinforcing said continuous polyolefin phase.

2. The weatherstrip according to claim 1 wherein the continuous thermoplastic polyolefin phase comprises a high density polyethylene compound.

3. The weatherstrip according to claim 1 wherein said glass contact layer comprises a continuous thermoplastic polyolefin phase in an amount greater than 80 weight percent.

4. The weatherstrip according to claim 1 wherein said glass contact layer comprises a continuous thermoplastic polyolefin phase in an amount between about 85 and 95 weight percent.

5. The weatherstrip according to claim 1 wherein said silicone-crosslinked network is a reaction product of silane-grafted polyolefin and a silicone polymer.

6. The weatherstrip according to claim 4 wherein said silane-grafted polyolefin is silane-grafted polyethylene.

7. The weatherstrip according to claim 5 wherein said silicone polymer is characterized by ultra high molecular weight.

8. The weatherstrip according to claim 5 wherein said silicone polymer is characterized by a molecular weight between about 300,000 and 400,000.

9. The weatherstrip according to claim 1 wherein said base extrusion is formed of a thermoplastic vulcanizate material.

10. The weatherstrip according to claim 1 wherein said base extrusion is formed of an ethylene-propylene rubber material.

11. A weatherstrip for sealing a window in a motor vehicle comprising:
a base extrusion and
a glass contact layer overlying a portion of said base extrusion, said glass contact layer being composed predominantly of a high density polyethylene compound and including a silicone-crosslinked network reinforcing said high density polyethylene compound.

12. The weatherstrip according to claim 11 wherein said glass contact layer comprises a continuous thermoplastic polyolefin phase in an amount greater than 80 weight percent.

13. The weatherstrip according to claim 11 wherein said glass contact layer comprises a continuous thermoplastic polyolefin phase in an amount between about 85 and 95 weight percent.

14. The weatherstrip according to claim 11 wherein said silicone-crosslinked network is a reaction product of silane-grafted polyolefin and a silicone polymer.

15. The weatherstrip according to claim 14 wherein said silane-grafted polyolefin is silane-grafted polyethylene.

16. A weatherstrip for sealing a glass window in a motor vehicle comprising:
a base extrusion and
a glass contact layer secured to a portion of said base extrusion, said glass contact layer comprising a high density polyethylene compound and a silicone-crosslinked network reinforcing said high density polyethylene compound.

17. The weatherstrip according to claim 16 wherein said glass contact layer comprises a continuous thermoplastic polyolefin phase in an amount greater than 80 weight percent.

18. The weatherstrip according to claim 16 wherein said glass contact layer comprises a continuous thermoplastic polyolefin phase in an amount between about 85 and 95 weight percent.

19. The weatherstrip according to claim 16 wherein said silicone-crosslinked network is a reaction product of silane-grafted polyolefin and a silicone polymer.

20. The weatherstrip according to claim 16 wherein said silane-grafted polyolefin is silane-grafted polyethylene.
